(19) United States
(12) Patent Application Publication
(10) Pub. No.: US 2015/0272078 A1
(43) Pub. Date: Oct. 1, 2015

(54) METHOD OF PRODUCING ANIMAL LITTER

(71) Applicant: UNICHARM CORPORATION, Ehime (JP)

(72) Inventors: Takeshi Ikegami, Kagawa (JP); Kenji Hiroshima, Kagawa (JP)

(21) Appl. No.: 14/673,540

(22) Filed: Mar. 30, 2015

Related U.S. Application Data
(60) Provisional application No. 61/972,618, filed on Mar. 31, 2014.

(51) Int. Cl. A01K 1/015; B01J 2/20

(52) U.S. Cl. CPC A01K 1/0154; B01J 2/20

(57) ABSTRACT

A method whereby, when a plurality of granulators are used for continuous production of animal litter from a molding material composed mainly of bentonite, it is possible to minimize any significant reduction in the amount of particulates granulated by the granulator and efficiently and continuously produce litter. Specifically, during granulation of particulates, the particle diameters of a prescribed number of the particulates granulated by the granulators are measured either continuously or at prescribed intervals for each granulator, the mean particle diameter of the particulates at the time of measurement is calculated for each granulator, and when the mean particle diameter of the particulates granulated by any one granulator of the granulators exceeds a first particle diameter, granulation is halted for the granulator in which the mean particle diameter of the particulates exceeds the first particle diameter, or when the average of the mean particle diameters of the particulates for all of the granulators exceeds a second particle diameter which is set to be a smaller particle diameter than the first particle diameter, granulation is halted for the granulator in which the greatest mean particle diameter of particulates among the granulators.

### RELATED APPLICATION

This application is based on U.S. Provisional Application Ser. No. 61/972,618, filed Mar. 31, 2014 to which priority is claimed under 35 U.S.C. §120, the complete disclosure of which is hereby expressly incorporated by reference.

### TECHNICAL FIELD

The present invention relates to a method of producing animal litter that is to be spread in an animal toilet for dogs or cats that are kept as indoor pets.

### BACKGROUND ART

Several types of litter exist for use in animal toilets for cats and the like that are raised indoors, among which there are known those that employ particulate forms (pellets) whose major starting material is a clay-like substance composed mainly of montmorillonite, commonly known as bentonite, that swells and exhibits cohesive force upon absorption of urine and fluids in excreta.

Litter formed using such types of bentonite as the starting material swell upon absorbing liquids and stick to the surrounding litter to form masses, thus offering the advantage of allowing excreta to be disposed of in a convenient manner by removal of the masses.

For production of litter using such bentonite as the starting material, it is common to form particulates using multiple granulators each mounting an exchangeable die provided with a plurality of through-holes having predetermined hole diameters, as described in PTL 1, for example. Specifically, a molding material composed mainly of bentonite, with water added, is loaded into the granulator, and the molding material is extruded through the through-holes by applying pressure to the die to granulate the particulates. Next, the granulated particulate matter is loaded into a heating furnace and heated, and then dried to continuously produce animal litter.

The granulator accomplishes granulation of the molding material by applying pressure to the die to extrude the particulates through the thr-holes of the die.

During this time, the molding material composed mainly of bentonite has a highly rough surface even when water is added, and when pressure is applied to the die for extrusion through the through-holes, the molding material acts as an abrasive, thus shaving and abrading the die and especially the inner peripheral surfaces of the through-holes. Consequently, it is currently the case that during granulation of the particulates, the die through-holes gradually increase in inner diameter due to abrasion, making it impossible to accomplish granulation of particulates with the originally determined particle diameters.

This creates variation in the particle diameters of litter held in the same packaging container, potentially preventing the product from having consistent quality. In particular, toilet litter has a smaller surface area per unit volume the larger the particle diameter, and lower absorbing power for animal excreta, it is undesirable in terms of quality control for a large amount of litter with particle diameters exceeding the allowable range to be present in the same bag or other packaging container.

In order to prevent granulation of such litter having particle diameters exceeding the allowable range, it is necessary to appropriately exchange the die before the inner diameters of the through-holes of the die become abraded to hole diameters outside of the allowable range.

When the die is exchanged, however, operation of the granulator must be temporarily halted in consideration of the construction of the granulator, and this has been a problem because no granulation can be accomplished during halted operation and the amount of granulation of the particulates in the production facility as a whole is reduced.

Particularly when multiple granulators are used for granulation of large amounts of particulates, if operation must be simultaneously halted for exchange of the dies for several of the plurality of granulated products, then the granulation amount is considerably reduced.

Furthermore, from the viewpoint of controlling the furnace temperature, the heating furnace used to heat and dry the granulated particulates preferably maintains as consistent a range as possible for the particulates loaded into the furnace, and therefore if the amount of particulates granulated by the granulator is significantly reduced, the temperature in the furnace increases causing overheating of the particulates, potentially lowering the quality of the litter product.

### CITATION LIST

### Patent Literature

[PTL 1] Japanese Unexamined Patent Publication No. 59-59240

### SUMMARY OF THE INVENTION

### Technical Problem

The technical problem of the invention is to provide a method of producing animal litter whereby, when a plurality of granulators are used for continuous production of animal litter from a molding material composed mainly of bentonite, it is possible to efficiently and continuously produce litter while minimizing any significant reduction in the amount of particulates granulated by the granulator.

### Solution to Problem

In order to solve this problem, the method of producing animal litter according to the invention is a method in which a molding material made from bentonite as the main starting material, with addition of water, is loaded into each of a plurality of granulators on which dies are exchangeable attached each provided with multiple through-holes with a predetermined hole diameter, the molding material is forced through the dies for extrusion through the through-holes to granulate the particulates, and then the particulates are heated and dried in a heating furnace to continuously produce animal litter,

wherein during granulation of the particulates, the particle diameters of a predetermined number of particulates granulated by the plurality of granulators are measured continuously or at prescribed intervals for each granulator, the mean particle diameter of the particulates is calculated for each granulator during measurement, and if any one of the granulators among the plurality of granulators has a mean particle diameter of the granulated particulates that exceeds a predetermined first particle diameter, granulation is halted for the granulator in which the mean particle diameter of the particulates exceeds the first particle diameter, or if the average of the mean particle diameters of the particulates of all of the granulators exceeds a predetermined second particle diameter, granulation is halted for the granulator in which the greatest mean particle diameter of the particulates among the plurality of granulators.

According to the invention, a granulator which has halted granulation among the plurality of granulators has its die exchanged with a die provided with through-holes having smaller hole diameter than the second particle diameter, allowing immediate resumption of granulation of the particulates.

Furthermore, according to the invention, when granulation of at least one of the plurality of granulators has been halted, and the amount of granulation of particulates by granulation with all of the plurality of granulators falls below the predetermined target amount of granulation of particulates, due to the effect of the granulator whose granulation has been halted, the amount of granulation of particulates of the other granulators can be increased in order to maintain the predetermined target amount of granulation of the particulates.

Alternatively, according to the invention, when at least one of the plurality of granulators is on standby with granulation halted, during granulation of the particulates with the other granulators, and then one of the other granulators halts granulation, the granulator on standby begins granulation in place of the granulator that has halted granulation, while the granulator that has halted granulation has its die exchanged with one that is provided with through-holes having hole diameter smaller than the first particle diameter and second particle diameter, after which it may be put on standby with its granulation halted until one of the other granulators has its granulation halted.

According to the invention, the first particle diameter is preferably 1.1 to 2.0 times the initial value of the hole diameter of the through-holes in the die.

Also according to the invention, the second particle diameter is preferably 1.05 to 1.5 times the initial value of the hole diameter of the through-holes in the die.

Also according to the invention, the die of the granulator preferably has a thickness of 1 to 100 mm.

Also according to the invention, the material of the die of the granulator may be iron, steel or stainless steel.

Also according to the invention, the molding material preferably has a water content of 15 to 40 mass % when loaded into the granulator.

### Advantageous Effects of Invention

According to the invention, the particle diameters of the particulates granulated by each granulator during granulation of particulates are measured, the mean particle diameters of the particulates of each granulator are calculated, and when the mean particle diameter in any one of the granulators of all of the plurality of granulators or the average of the mean particle diameters of the particulates of all of the granulators exceeds a prescribed particle diameter, granulation by a specific single granulator is halted.

This can prevent granulation of particulates exceeding the allowed particle diameter, while also minimizing variation in the particle diameters of the particulates to be granulated by each granulator, so that quality reduction of the litter can be minimized.

Furthermore, since it is possible to keep the number of halted granulators to a minimum and thus avoid simultaneously halting multiple granulators as much as possible, the method can prevent reduction in the amount of granulation of particulates and maintain a constant amount of granulation.

### BRIEF DESCRIPTION OF THE DRAWINGS

FIG. 1 is a diagram schematically showing an example of production equipment for carrying out a method for producing animal litter according to the invention.

FIG. 2 is (a) a cross-sectional view from the front side and (b) a cross-sectional view from the top side, schematically showing an example of a granulator in the production equipment of FIG. 1.

FIG. 3 is a flow chart showing the flow of treatment and control during the granulation step in a method for producing animal litter according to the invention.

FIG. 4 is a cross-sectional view schematically showing a die having a different construction from the die in the granulator of FIG. 2. Parts are omitted in this diagram.

### DESCRIPTION OF EMBODIMENTS

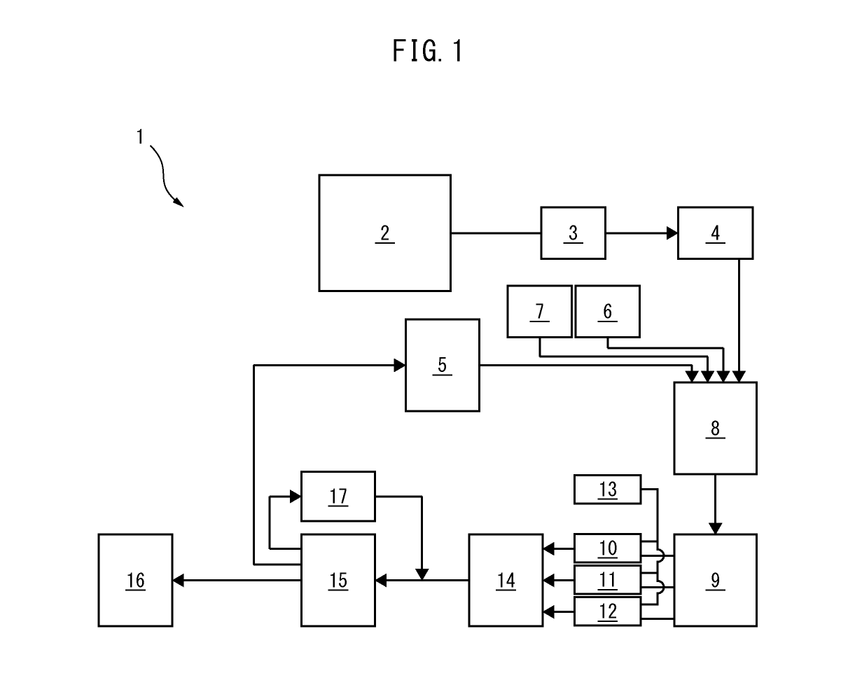

For more detailed illustration of the method of producing animal litter according to the invention, FIG. 1 to FIG. 3 show an example of production equipment for carrying out an embodiment of a method of producing animal litter according to the invention.

Specifically, as shown in FIG. 1, the production equipment 1 comprises a stock yard 2 that stores bentonite crude ore as the main starting material, a crude ore mineral crusher 3 such as a roll mill, hammer mill or pin mill, that crushes the bentonite crude ore delivered from the stock yard 2 to the prescribed size, and a crushed bentonite storage container 4 that stores the bentonite that has been crushed by the crusher 3 and freely exports the prescribed amount as appropriate.

The production equipment 1 also has a powdered bentonite storage container 5 that stores the powdered bentonite to be used as the starting material for the animal litter and that freely exports the prescribed amount as apparatus, and an additive storage container 6 that stores additives such as sodium carbonate to be mixed in during production of the molding material 19 described below, and that freely exports a predetermined amount as appropriate.

In addition, it is provided with a water storage container 7 that stores water to be added during kneading of the starting material for the molding material, and appropriately pumps a predetermined amount by a pump.

A storage container for mixing of other additives with the molding material 19 may also optionally be provided in addition to the different containers mentioned above, for addition of various additives to the molding material 19. Examples of such additives include inorganic materials such as acidic white clay, silica gel, diatomaceous earth, diatomaceous shale, allophane, zeolite, sepiolite, attapulgite or any of their derivatives, plant-based materials such as paper, virgin pulp, regenerated pulp (pulp regenerated from paper), pulp sludge, bamboo wood, starch, corn, soybean, okara and the like, and synthetic resin-based materials such as super-absorbent polymers.

The production equipment 1 may also comprise a kneader 8 that kneads each of the starting materials conveyed from the crushed bentonite storage container 4, the powdered bentonite storage container 5 and the additive storage container 6, with addition of water pumped from the water storage container 7, to form the molding material 19, and a molding material storage container 9 that temporarily stores the molding material formed by the kneader 8.

In addition, the production equipment 1 has a plurality of granulators that granulate pellet-like (essentially cylindrical) particulates 20 by the molding material 19 conveyed from the molding material storage container 9.

For this embodiment, three granulators, which are first to third granulators 10 to 12, all having the same construction and the same performance, are used, the first to third granulators 10 to 12 being connected to a controller 13 that controls driving of an electric motor or the like as the driving source, and that monitors granulation by the granulators 10 to 12.

The production equipment 1 also comprises a heating furnace 14 that heats and dries the particulates 20 that have been granulated by the first to third granulators 10 to 12, a sieve device 15 that sifts the particulates 20 dried by the heating furnace 14 according to particle diameter, and a storage container 16 that stores particulates 20 having suitable particle diameters, as the product sifted by the sieve device 15.

The kneader 8 may be a kneader with any desired construction so long as it allows the starting materials to be reliably and stably kneaded to form a molding material 19 of basically consistent quality, but it is preferred to use a kneader suited for kneading of powder (for example, an Eirich mixer).

Also, the heating furnace 14 may be any type of heating furnace that can suitably heat and dry the particulates 20 that have been granulated by the granulators 10 to 12, and for example, it is preferred to use a rotary kiln furnace that allows simultaneous and continuous loading, heating and export of the particulates.

In addition, the granulators 10 to 12 may be publicly known types so long as they can form pellet-like particulates 20, and for example, a granulator such as described in PTL 1 mentioned above may be used.

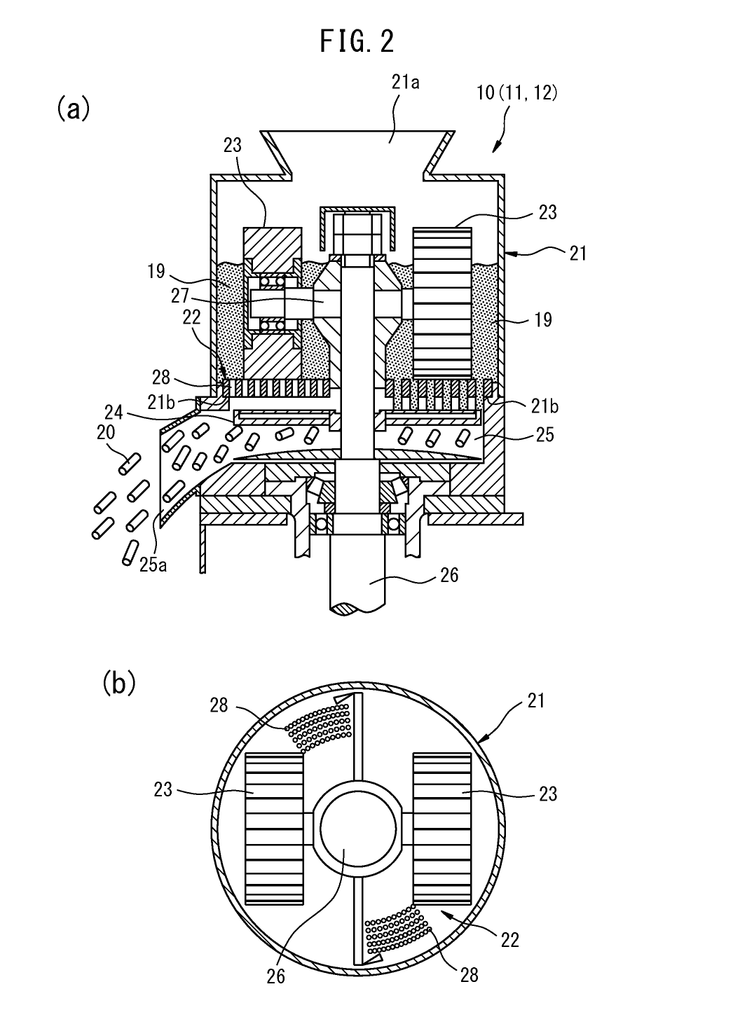

Specifically, as shown in FIGS. 2(a) and (b), the granulators 10 to 12 for this embodiment all comprise a body section 21 formed into a tube, provided with a loading port 21a through which the molding material 19 is loaded at the top end, a flat die 22 mounted in a detachable manner at the bottom of the body section and provided with through-holes running through the thickness direction (the vertical direction), and a plurality of rotors 23 that tumble the top side of the die within the body section. In addition, it has a rotary blade 24 installed below the die 22, that rotates in a direction along the flat surface of the die 22, and a rotary blade chamber 25 that surrounds the perimeter of the rotary blade 24 in a state of non-contact with the rotary blade 24, and that comprises an outlet 25a that discharges cut material (i.e. particulates 20) that has been cut by the rotary blade 24.

The rotor 23 is formed in an essentially cylindrical fashion, and by rotating the drive shaft 26 that is linked with the output shaft of an electric motor or the like, the top side of the die 22 tumbles freely around the rotation center which is a supporting shaft 27 mounted on the drive shaft 26.

In the case shown in FIGS. 2(a) and (b), two rotors 23 are provided, and each of the rotors 23 is in a state of constant contact with or at an appropriate gap (clearance) from the top side of the die 22, at the section located on the bottom edge side of the outer peripheral surface during tumbling. Thus, each of the rotors 23 presses the molding material 19 loaded in the body section 21 against the die 22 by its outer peripheral surface, pushing the molding material 19 into the through-holes 28 (described below) of the die 22, and allowing the molding material 19 to be extruded to the lower side of the die 22 through the through-holes 28. As a result, the molding material 19 is extruded to the lower side of the die 22 into essentially cylindrical shapes having outer diameters (particle diameters) that are essentially equal to the hole diameters of the through-holes 28, and then sent into a cutting blade chamber 25.

The die 22, on the other hand, is a discoid shape formed from one sheet made of a material such as iron, steel or stainless steel, and several through-holes 28 having the same diameter (initial values) are provided at approximately equal spaces.

The die 22 has its lower side perimeter held at the bottom of the body section 21 by being caught and engaging with protrusions 21b provided on the inner peripheral surface of the body section 21, while the rotor 23 on the top side is situated in a freely tumbling manner.

The thickness of the die 22 may be set as desired within a range that can ensure sufficient rigidity to withstand granulation of the particulates, and according to the invention, this is preferably about 1 to 100 mm, more preferably about 1 to 50 mm and even more preferably about 1 to 10 mm, depending on the sizes of the particulates to be granulated. If it is smaller than 1 mm, it will not be able to withstand the pressing force of the rotor through the molding material 19, and the die will be highly susceptible to early bending or collapse. If it is greater than 100 mm, a very strong force will be necessary to extrude the molding material through the through-holes, and this will place a large load on the granulator as a whole centered on the rotor or die, potentially risking breakage or damage in the granulator.

For this embodiment, the die 22 is hardened by surface treatment such as nitriding or quenching of the surface.

Such surface treatment such as nitriding or quenching of the surface of the die 22 can reduce to a minimum the abrasion that occurs with tumbling of the rotor 23, or abrasion generated between the inner peripheral surfaces of the through-holes and the molding material 29 during extrusion of the molding material 19 through the through-holes 28 by the rotor 23, thereby reducing the frequency with which the die 22 must be exchanged.

That is, when extruding the molding material through the through-holes, the die tends to be abraded due to powerful pressing force from the rotor, either via the molding material or directly if it is in contact therewith, and since the bentonite as the main starting material of the molding material also functions as an abrasive, the surface of the die is shaved and abraded by this abrasion.

For this embodiment, therefore, surface treatment is carried out by nitriding or quenching on the surface of the die 22, thereby hardening the surface of the die 22.

In addition, the rotary blade 24, which cuts to the prescribed lengths the essentially cylindrical molding material 19 that has been extruded from the die 22 and entered the cutting blade chamber 25, is mounted on the drive shaft 26 and rotates in the direction along the flat surface of the die 22 together with the drive shaft 26.

The molding material 19 cut by the rotary blade 24 is in the form of pellets, i.e. particulates 20, and is discharged to the exterior of the granulators 10 to 12 from the outlet 25a of the cutting blade chamber 25, being then sent to the storage container 16.

A method of producing animal litter according to the invention in the production equipment 1 will now be described.

The basic flow for production of animal litter is as follows.

Specifically, there are carried out a loading step in which a molding material 19 comprising bentonite as the main starting material and with water added, is loaded into each of the first to third granulators 10 to 12, and a granulation step in which the granulators 10 to 12 are driven to granulate particulates 20 from the molding material 19. After the granulation step, a drying step is carried out in which the granulated particulates 20 are heated and dried in a heating furnace 14, for continuous production of animal litter as the product.

First, after producing the molding material 19 comprising bentonite as the main starting material in the loading step, the molding material 19 is loaded into the first to third granulators 10 to 12 by a conveying apparatus such as a belt conveyor.

Production of the molding material 19 in the loading step is accomplished by loading a prescribed amount of the prescribed starting material into the kneader 8, adding water, and kneading.

Specifically, crude ore is delivered from the bentonite crude ore stock yard 2 while the delivered crude ore is crushed to an appropriate size with a crusher 3 for the crude ore, and a predetermined amount of bentonite is transported from the storage container for the crushed bentonite which is to store the crushed bentonite, and loaded into the kneader 8.

Meanwhile, a predetermined amount of the powdered bentonite is loaded from the powdered bentonite storage container 5 into the kneader 8, to increase the surface area of the particulates 20 when the molding material 19 has been formed into particulates 20. Also, a prescribed amount of additives such as soda ash and sodium hydroxide are loaded into the kneader 8 from the additive storage container 6, for alkali treatment of the bentonite in order to increase the liquid absorption property of the pet litter product.

The kneader 8 is driven and each starting material is kneaded after addition of water, to produce molding material 19.

The produced molding material 19, after being removed from the kneader 8, is conveyed to the first to third granulators 10 to 12 by a conveying apparatus such as a belt conveyor, and loaded into each of the body sections 21 of the granulators 10 to 12.

The amount of crushed bentonite loaded into the kneader 8 is 100 to 1500 kg, and the amount of additives is about 0.1 to 50 mass %.

The water to be added during kneading is an amount for a water content of 15 to 40 mass % in the molding material 19 during loading of the molding material 19 into the first to third granulators 10 to 12. If the water content is less than 15 mass %, the moldability during granulation will be poor and a fine powder will tend to be generated to a significant degree. If it exceeds 40 mass %, on the other hand, the rigidity of the particulate will be reduced and it may be difficult to retain the form as a result of its softness.

In the subsequent granulation step, each of the first to third granulators 10 to 12 is driven, and the molding material 19 loaded into the body section 21 is extruded from the through-holes 28 toward the lower side of the die 22 by pressing force on the die 22 by the rotor 23, to successively granulate pellet-like particulates 20.

While continuous granulation of the particulates 22 is being carried out by the first to third granulators 10 to 12 during this granulation step, the following processing and control are also carried out at each of the granulators 10 to 12.

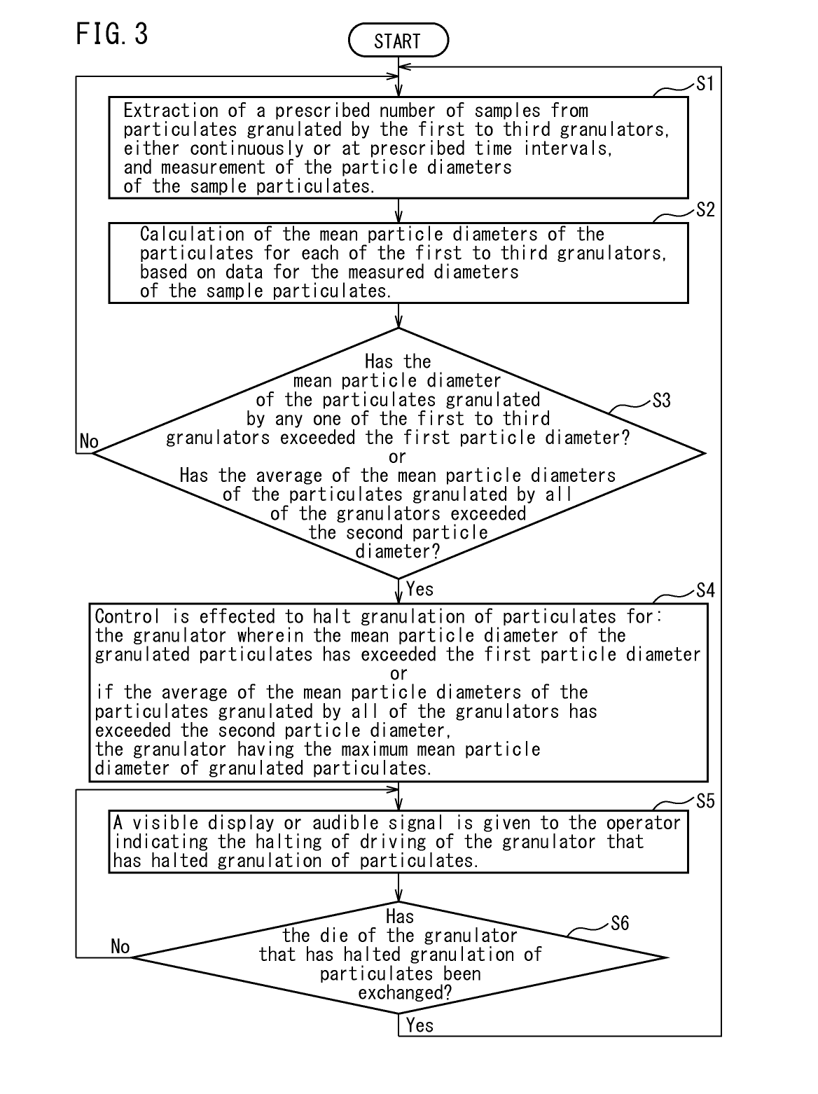

Specifically, as shown in the flow chart in FIG. 3, there are carried out in order a first step S1 in which the particle diameters of a predetermined number of particulates 20 granulated by the first to third granulators 10 to 12 are measured either continuously or at prescribed intervals for each of the granulators 10 to 12, and a second step S2 in which the mean particle diameter for the particulates 20 of each of the granulators 10 to 12 is calculated based on the data for the measured particle diameters obtained in the first step S1.

There are also further carried out in order a third step S3 in which, based on the mean particle diameter for the particulates 20 of each of the granulators 10 to 12 calculated in the second step S2, it is determined whether or not the mean particle diameter for each granulator or the average of the mean particle diameters of all of the granulators 10 to 12 satisfies a given condition, and a fourth step S4 in which, if it has been judged in third step S3 that the given condition is met, control is effected so that granulation of a prescribed granulator is halted.

The steps following the fourth step S4 are for resetting of the granulator that has halted granulation, and will be explained below.

In this granulation step, the first to third granulators 10 to 12 may be all driven at a given timing, such as at initial operation of the production equipment 1, or the initial driving time may be shifted for any or all of the granulators.

In the first step S1, a predetermined number of the particulates 20 granulated by the first to third granulators 10 to 12 are used as samples for extraction from each of the granulators 10 to 12, either continuously or at prescribed intervals. The particle diameters of the sample particulates 20 are each measured.

Extraction of the particulates 20 to be used as samples is carried out constantly if it is continuous, or if it is carried out at a given time interval it is preferably done every 5 to 60 minutes.

The particle diameters of the particulates, according to the invention, means the lengths of the pellet-like particulates in the direction perpendicular to the axis line directions, or in other words the diameters of the outer peripheral surfaces of the particulates.

Also, measurement of the particle diameters of the particulates is accomplished by measuring the diameters of the outer peripheral surfaces of the particulates at a plurality of locations (for example, 3 or more locations), and recording the average value of the measured diameter as the particle diameter of the measured particulates. For the measurement, locations unsuitable as measuring locations, such as sections that have a clearly chipped or swollen outer appearance, are not measured.

Measurement of the particulate diameters is carried out using known measuring means such as a caliper or micrometer, or a laser diffraction/scattering particle size meter. The data for the values after calculating the average value for the particle diameters of the particulates (=the particle diameters of the individual particulates) are sent to the controller 13 each time the particulates are measured.

In the subsequent second step S2, the mean particle diameters of the particulates are calculated for each of the first to third granulators 10 to 12, based on the data for the particle diameters of the particulates 20 used as samples that were measured in the first step S1.

Thus, the size of the mean particle diameter of the particulates 20 for each of the granulators 10 to 12 is obtained with the measuring point being during the first step S1.

Calculation of the mean particle diameter of the particulates 20 of each of the granulators 10 to 12 is carried out at the controller 13.

Also, in the third step S3, it is judged whether or not the mean particle diameter of the particulates 20 granulated by any one of the granulators among the first to third granulators 10 to 12 has exceeded the predetermined first particle diameter, or whether or not the average of the mean particle diameters of the particulates 20 granulated by the first to third granulators 10 to 12, i.e. all of the granulators 10 to 12, has exceeded the predetermined second particle diameter.

This judgment is carried out at the controller 13, and when the controller 13 judges that none of the mean particle diameters of the particulates granulated by the granulators exceed the first particle diameter or that the average of the mean particle diameters of the particulates granulated by all of the granulators does not exceed the second particle diameter, the flow returns to the first step S1 and the processing of the first to third steps S1-S3 is repeated. On the other hand, when the controller 13 has judged that either the first particle diameter or second particle diameter has been exceeded, flow proceeds to processing of the fourth step S4.

The third step S3 is carried out in order to ensure the performance and quality of the individual animal litter products produced, and to ensure the overall performance and quality of the animal litter for each packaging container, when the animal litter is filled into packaging containers such as bags as a product.

In this regard, the first particle diameter is the maximum particle diameter of the particulates that can ensure performance and quality of the animal litter as a product, when the particulates 20 of each of the first to third granulators 10 to 12 are granulated.

If the particle diameter of the particulates exceed the first particle diameter, the compressive force on the particulates during granulation will be reduced resulting in poor moldability, and dusting may be generated thus lowering the quality of the particulates.

With a granulator wherein the mean particle diameter of the granulated particulates exceeds the first particle diameter, it is highly probable that the granulator has already granulated sizes exceeding the first particle diameter at the time of measurement of the particle diameter (while carrying out the first step S1), and therefore in order to ensure performance and quality as an animal litter product, it is necessary to halt granulation and exchange the die with one having through-holes with suitable hole diameter.

On the other hand, when the animal litter product is to be filled into a packaging container such as a bag, the second particle diameter is the maximum average of the particle diameters of the particulates in each packaging container thereby allowing maintenance of the performance and quality to be ensured for the animal litter in each packaging container.

In other words, if the average of the particle diameter of the particulates in each packaging container exceeds the second particle diameter, the number of animal litter particles per unit volume will be reduced, thereby excessively lowering the overall surface area of the animal litter packed into each packaging container, reducing the liquid absorption volume per packaging container and making it difficult to ensure the desired liquid absorption performance.

Consequently, if the average of the mean particle diameters of the particulates granulated by all of the granulators exceeds the second particle diameter, there will be a high potential that the overall performance and quality of the animal litter in each packaging container may not be ensured when the animal litter product produced from the particulates is filled into the same packaging container. Thus, in order to ensure the performance and quality of the animal litter product, it is necessary take measures so as to lower the average value for the mean particle diameters of the particulates granulated by all of the granulators.

According to the invention, therefore, it is judged whether or not the mean particle diameters of any of the granulators exceed the first particle diameter, or whether or not the average of the mean particle diameters of all of the granulators exceeds the second particle diameter, and by subsequent driving control of each granulator, it is possible to constantly maintain the overall performance or quality of different animal litter products or animal litter packaged in the same container.

The first particle diameter is preferably 1.1 to 2.0 times, more preferably 1.1 to 1.8 times and even more preferably 1.1 to 1.5 times the hole diameter (initial value) of the through-holes formed in the die. If the first particle diameter is less than 1.1 times the hole diameter of the through-holes, the effect on the absorption property per unit volume of the particulates and the moldability will be minimal and negligible, requiring little need for halting of granulation. If it exceeds 2.0 times, on the other hand, the moldability will be significantly impaired.

The second particle diameter is basically smaller than the first particle diameter, and is preferably 1.05 to 1.5 times, more preferably 1.05 to 1.2 times and even more preferably 1.05 to 1.1 times the hole diameter (initial value) of the through-holes formed in the die. If the first particle diameter is less than 1.05 times the hole diameter of the through-holes, the effect on the absorption performance per unit volume of the particulates will be minimal and negligible, requiring little need for halting of granulation. If it is greater than 1.5 times, on the other hand, the absorption property per unit volume of the particulates will be significantly reduced.

Also, in the fourth step S4, if it has been judged in the third step S3 that the mean particle diameter of the particulates granulated by any one of the granulators among the first to third granulators 10 to 12 exceeds the first particle diameter, the controller 13 carries out control to halt granulation of the granulator that has granulated particulates exceeding the first particle diameter. For example, if it has been judged that the mean particle diameter of the particulates 20 granulated by the third granulator 12 exceeds the first particle diameter, then in the fourth step S4 the controller 13 carries out control to halt granulation by the third granulator 12.

Alternatively, when it has been judged in the third step S3 that the average of the mean particle diameters of the particulates 20 granulated by all of the granulators, i.e. the first to third granulators 10 to 12, exceeds the second particle diameter, the controller 13 carries out control to halt granulation of the granulator with the greatest mean particle diameter of granulated particulates among the first to third granulators 10 to 12. For example, if the second granulator 11 has the greatest mean particle diameter of granulated particulates 20 among the first to third granulators 10 to 12, even if the mean particle diameter of the particulates 20 granulated by the second granulator 11 does not exceed the first particle diameter, the controller 13 carries out control to halt granulation by the second granulator 11.

When the fourth step S4 is performed to carry out control to halt granulation of any of the granulators, the halting of granulation is actually accomplished by halting driving of the driving source such as the electric motor of the granulator in which granulation is to be halted.

When driving of the granulator is to be halted, first driving of the conveying apparatus for loading of the molding material into the granulator to be halted is halted, so that the molding material is no longer conveyed to the granulator to be halted.

Also, when it has been judged during the third step S3 that there is a granulator that must halt granulation, the molding material already loaded into the granulator still remains there, but basically granulation of the particulates is continued using that molding material, and driving of the granulator is halted after the molding material has been fully used.

For this embodiment, no particular control is carried out on the two granulators other than the granulator that has halted granulation of the particulates 20, i.e. the granulators that are continuing granulation, and they maintain their state of granulating particulates while the controller 13 subsequently returns the flow to the first step S1 to repeat the processing for driving control of each granulator. For example, when granulation of the third granulator 12 has been halted, the other first granulator 10 and second granulator 11 continue to perform granulation of the particulates 20, and the controller 13 returns processing for driving control of the first granulator 10 and second granulator 11 to the first step S1 and repeats it.

Thus, in the granulation step, carrying out the first to fourth steps S1-S4 allows the states of the first to third granulators 10 to 12 to be constantly monitored during granulation of the particulates 20, to reliably prevent reduction in the performance and quality of the animal litter product.

Next, after the fourth step S4 in the granulation process, processing and control are carried out for restoration of the granulator that has halted granulation.

Specifically, the operator is alerted that driving of the halting granulator has been halted, upon which there are carried out a fifth step S5 which is exchange of the die 22 of that granulator, a sixth step following the fifth step S5, in which it is judged whether or not the die 22 has been exchanged, and a seventh step S7 in which control is performed to resume driving of the granulator whose die 22 has been exchanged.

After the fifth step S5 has effected control to halt driving of the granulator that has been halted by the fourth step S4, the operator is alerted that driving of the granulator to be halted has been halted, by a visual display or a sound produced by a monitor or the like.

By carrying out the fifth step S5, the operator that has been alerted of the presence of a granulator whose granulation has been halted performs an operation or direction for exchange of the die 22 of the granulator whose granulation has been halted to a die 22 having through-holes 28 with the initial value hole diameter (a hole diameter that is at least smaller than the second particle diameter).

As a result, when the granulator whose granulation has been halted has had its granulation halted because the mean particle diameter of the granulated particulates 20 exceeds the first particle diameter, exchange of the die 22 eliminates the condition in which the mean particle diameter of the particulates 20 being granulated exceeds the first particle diameter.

On the other hand, when the granulator whose granulation has been halted has had its granulation halted because the average of the mean particle diameters of the particulates granulated by all of the first to third granulators 10 to 12 exceeds the second particle diameter, exchange of the die 22 causes the particle diameters of the granulated particulates 20 to return to the allowable range in the granulator whose granulation has been halted, and thus eliminates the condition in which the average of the mean particle diameters of the particulates 20 granulated by all of the granulators 10 to 12 exceeds the second particle diameter.

In the sixth step S6, it is judged whether or not the die 22 of the granulator whose granulation has been halted has been exchanged by carrying out the fifth step S5. In actuality, when exchange of the die 22 of the granulator with granulation halted has been completed, this is judged by the controller 13 based on whether or not information that exchange of the die 22 has been completed has been sent to the operator. Furthermore, when information has been sent that exchange of the die has been completed, the controller 13 carries out the following seventh step S7, and when such information has not been sent it returns flow to the fifth step S5, subsequently notifying that driving of the granulator to be halted has been halted, and indicating the need for exchange of the die 22 of that granulator.

In the seventh step S7, when the controller 13 has recognized that exchange of the die 22 of the granulator that has halted granulation has been completed, upon carrying out the sixth step S6, the controller 13 effects control to resume driving of the granulator that has had its die 22 exchanged.

Thus, immediately after the granulator that has halted granulation has had its die exchanged with a die provided with through-holes 28 having a smaller hole diameter than the second particle diameter, granulation of the particulates 20 resumes.

Incidentally, control for resuming driving of the granulator that has had its die 22 exchanged controls not only driving of the granulator itself, but also resumption of driving of the conveying apparatus that loads the molding material 19 into the granulator, thereby initiating loading of the molding material 19 into the granulator.

After carrying out the seventh step S7, the production equipment 1 returns to a steady state in terms of granulation of the particulates 20, and the controller 13 basically returns the flow to the first step S1 to repeat processing for driving control of each granulator.

After the granulation step, the granulated particulates 20 are transported to the heating furnace 14 by a conveying apparatus such as a belt conveyor, and the particulates 20 are loaded into the heating furnace 20 for a drying step in which the particulates 20 are heated and dried.

The furnace temperature of the heating furnace 14 in the drying step will differ depending on the components of the particulates 20 (mainly the bentonite and water content) and on the sizes and amount of particulates, but in general the furnace temperature is preferably about 100 to 1000° C., more preferably about 150 to 900° C. and even more preferably about 200 to 800° C.

The heating time will also differ depending on the components of the particulates 20 and on the sizes and amount of particulates, and when the mass of the particulate is 2 t (2000 kg), for example, it is preferably about 20 to 180 minutes, more preferably about 30 to 150 minutes and even more preferably about 40 to 120 minutes.

After completion of the drying step, the dried particulates 20 are sent to a sieve device 15 that accomplishes sifting according to particle diameter, and only the particulates 20 having particle diameters suitable for an animal litter product are sifted and selected out by the sieve device 15, and transported to the storage container 16. At this time, as shown in FIG. 1, the particulates 20 having particle diameter smaller than the suitable particle diameter (undersizes) and the powder generated by chipping of portions of the particulates 20 are treated the same as the powdered bentonite and conveyed to the powdered bentonite storage container by a conveying apparatus such as a belt conveyor, and stored for reuse. Meanwhile, the particulates with particle diameters exceeding the suitable particle diameter are pulverized by a pulverizer 17 such as a hammer mill, and then resent to the sieve device 15 and sifted according to particle diameter.

Also, the particulates 20 transported to the storage container 16 are treated as animal litter product and subjected to prescribed processing such as addition of aromatic components, after which they are filled in prescribed amounts into respective packaging containers such as bags at packaging equipment (not shown), and shipped.

Thus, according to the method of producing animal litter, the particle diameters of the particulates 20 granulated by the first to third granulators 10 to 12 are each measured during granulation of the particulates 20, and the mean particle diameters of the particulates 20 are calculated for each of the first to third granulators 20 to 12. In addition, if the mean particle diameter of one of the granulators among the first to third granulators 10 to 12, or the average of the mean particle diameters of the particulates 20 of all of the granulators, exceeds the prescribed particle diameter, granulation is halted at one granulator according to the predetermined control procedure.

This can prevent granulation of particulates 20 exceeding the allowed particle diameter, while also minimizing overall variation in the particle diameters of the particulates to be granulated by all of the first to third granulators 10 to 12, so that quality reduction of the litter can be minimized.

Furthermore, since it is possible to keep the number of halted granulators to a minimum and thus avoid simultaneously halting multiple granulators as much as possible, the method can prevent reduction in the amount of granulation of the particulates 20 and maintain a constant amount of granulation.

For this embodiment, in the granulation process described above, the target is only the granulator that has halted granulation of the particulates 20 by carrying out the fourth step S4, for focus on processing and control for early resumption of granulation of the particulates 20 in the granulator that has halted granulation, while no special control is carried out for the other granulators that continue to perform granulation of the particulates 20.

However, when at least one of the plurality of granulators has halted granulation, it is assumed that the effect of the granulator that has halted granulation may prevent the amount of granulation of particulates granulated by all of the plurality of granulators from being maintained at the predetermined target for the amount of granulation of particulates by the production equipment.

In such cases, the amount of granulation of particulates may be increased in the other granulators that have not halted granulation, to maintain the predetermined target amount of granulation of particulates.

Specifically, at the stage where the fourth step S4 has been carried out or at the stage where the fifth step S5 has been carried out, for example, the tumbling speed of the rotors of the granulators that are granulating the particulates 20 may be increased either gradually or rapidly, and the amount of molding material 19 being extruded from the through-holes 28 of the die 20 of those granulators may be increased to gradually or rapidly increase the amount of granulation of particulates per unit time in each of the granulators.

In such a case, when exchange of the die of the granulator that has halted granulation has been completed and granulation of the particulates is resumed, i.e. when the seventh step S7 has been carried out, from the viewpoint of equipment safety, preferably the tumbling speed of the rotor of the granulator that has an increased amount of particulate granulation is restored to the normal speed and the amount of molding material extruded from the through-holes of the die is restored to the normal amount to adjust the amount of granulation, thereby lowering the load on each of the granulators.

Furthermore, in this embodiment, the three first to third granulators 10 to 12 are used and basically all of the first to third granulators 10 to 12 are driven for granulation of the particulates 20.

However, at least one of the plurality of granulators may be put on standby with granulation halted while the other granulators are granulating the particulates, and when one of the other granulators has halted granulation, the granulator(s) on standby may have granulation initiated in place of the granulator that has halted granulation. In this case, after the granulator that has halted granulation has been exchanged with a die comprising through-holes having smaller hole diameter than the first particle diameter and second particle diameter, it is placed on standby with granulation halted, until one of the other granulators halts granulation.

More specifically, in the production equipment 1 of this embodiment, when one of the first to third granulators 10 to 12, such as the third granulator 12, has a mean particle diameter of granulated particulates 20 that exceeds the first particle diameter, or when the average of the mean particle diameters of the particulates 20 granulated by all of the first to third granulators 10 to 12 exceeds the second particle diameter, control is effected to halt granulation by the third granulator 12 if the mean particle diameter of the particulates 20 granulated by the third granulator 12 is the largest.

Next, the die 22 of the third granulator 12 is exchanged, but the third granulator 12 that has had its die 22 exchanged is placed on standby with halted granulation, without immediately resuming granulation of particulates 20 as in the embodiment described above.

Also, when either the first granulator 10 or second granulator 11 that is continuing granulation of the particulates 20, such as the second granulator 11, has a mean particle diameter of granulated particulates 20 that exceeds the first particle diameter, granulation by the second granulator 11 is halted while the third granulator 12 that had its granulation halted is driven to resume granulation of the particulates 2. Incidentally, after the die 22 has been exchanged in the second granulator 11 that has halted granulation, it is put on standby with its granulation halted until the next granulator appears that is to have its granulation halted.

This allows the system to be such that there are constantly present a granulator that granulates particulates and a substitute granulator that is on standby without granulating, so that when substitution of the granulator is necessary the substitute granulator can be immediately driven.

Since it is therefore possible to maintain a state where multiple (two in the example described above) granulators are always granulating particulates, it is possible to reliably avoid a condition in which all of the granulators simultaneously have halted granulation, and to prevent drastic reduction in the amount of granulation of particulates.

In this case, since there is essentially one less granulator performing granulation of particulates, it may fall below the predetermined target amount of granulation of particulates, in which case the amount of granulation of particulates by the granulators that have not halted granulation may be increased to maintain the predetermined target amount of particulate granulation, or to approach the target amount of granulation.

Alternatively, a fourth granulator may be separately prepared in addition to the first to third granulators 10 to 12, so that when there is a condition such that one of the first to third granulators 10 to 12, such as the third granulator 12, must be halted, the fourth granulator may be driven in place of the third granulator 12 to initiate granulation of the particulates 20. In addition, after the die 22 has been exchanged in the third granulator 12 that has halted granulation, it is placed on standby with granulation halted until the next granulator appears that is to have its granulation halted, and once the granulator to have its granulation halted is specified, the third granulator 12 that is on standby is driven in place of the granulator that has its granulation halted, to initiate granulation.

This allows the system to be such that there are constantly present a granulator that granulates particulates and a substitute granulator that is on standby without granulating, so that when substitution of the granulator is necessary the substitute granulator can be immediately driven.

In this case, since it is possible to constantly maintain a condition of granulating particulates by the normal number of granulators, there is virtually no reduction in the amount of granulation by the production equipment, and since it is assured that one granulator will definitely be on standby, this has the advantage of minimizing the load on the granulators compared to a situation in which the granulators are always being driven.

Furthermore, although three granulators, the first to third granulators 10 to 12, were used in the granulation process of this embodiment, the number of granulators need only be more than one and may be only two, or it may be four or more, being set as desired according to the target amount of granulation and the scale of the equipment.

Also in this embodiment, the die 22 had a construction formed from a single flat plate.

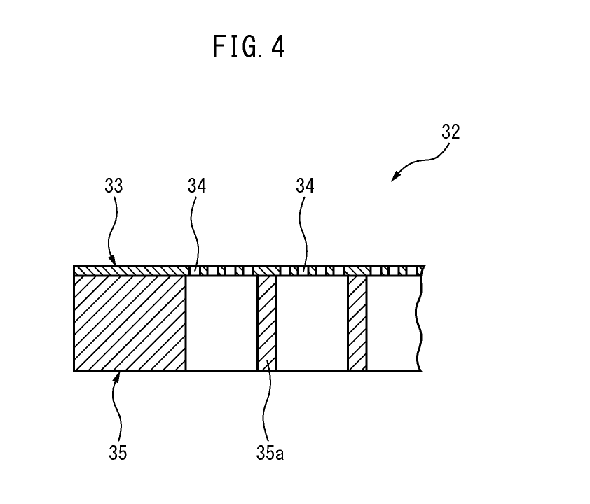

However, the die may instead have a construction comprising a plate member 33 having the through-holes 34, and a reinforcing member 35 holding the plate member 33 in a reinforced state, formed in a mountable state allowing exchange of the plate member 33 on the top end, such as the die 32 shown in FIG. 4. The necessary thickness of the die is ensured by the thicknesses of the plate member 33 and the reinforcing member 35.

However, the plate member 33 preferably has a thickness of at least 1 to 10 mm, in order to ensure the lengths of the through-holes 34 (i.e. the lengths in the thickness direction of the plate member 33) necessary for reliable and stable granulation of particulates with the desired particle diameters. Furthermore, it is essential for the reinforcing member 35 to have a construction that does not interfere with movement of the molding material through the through-holes 34, and that functions as reinforcement to minimize bending of the plate member 33 (for example, being provided with ribs 35a supporting the flat surface of the plate member 33 as shown in FIG. 4).

Incidentally, although this embodiment relates to animal litter having particulates 20 granulated into pellet forms (essential cylindrical shapes), the individual granulated product shapes, i.e. the shapes of the individual animal litter particles, may have any of various other shapes such as spherical or square columnar shapes.

### EXPLANATION OF SYMBOLS

10 to 12 Granulators
14 Heating furnace
19 Molding material
20 Particulate
22 Die
28 Through-hole

1. A method of producing animal litter in which a molding material made from bentonite as the main starting material, with addition of water, is loaded into each of a plurality of granulators on which dies are exchangeably attached each provided with multiple through-holes with a predetermined hole diameter, the molding material is forced through the dies for extrusion through the through-holes to granulate the particulates, and then the particulates are heated and dried in a heating furnace to continuously produce animal litter,
wherein during granulation of the particulates, the particle diameters of a predetermined number of particulates granulated by the plurality of granulators are measured continuously or at prescribed intervals for each granulator, the mean particle diameter of the particulates is calculated for each granulator during measurement, and
if any one of the granulators among the plurality of granulators has a mean particle diameter of the granulated particulates that exceeds a predetermined first particle diameter, granulation is halted for the granulator in which the mean particle diameter of the particulates exceeds the first particle diameter,
or if the average of the mean particle diameters of the particulates of all of the granulators exceeds a predetermined second particle diameter, which is set to be a smaller particle diameter than the first particle diameter, granulation is halted for the granulator in which the greatest mean particle diameter of the particulates among the plurality of granulators.

2. The method of producing animal litter according to claim 1, wherein the granulator which has halted granulation among the plurality of granulators has its die exchanged with a die provided with through-holes having a smaller hole diameter than the second particle diameter, allowing immediate resumption of granulation of the particulates.

3. The method of producing animal litter according to claim 1, wherein, when granulation of at least one of the plurality of granulators has been halted, and the amount of granulation of particulates by granulation with all of the plurality of granulators falls below the predetermined target amount of granulation of particulates, due to the effect of the granulator whose granulation has been halted, the amount of granulation of particulates of the other granulators is increased in order to maintain the predetermined target amount of granulation of the particulates.

4. The method of producing animal litter according to claim 1, wherein when at least one of the plurality of granulators is on standby with granulation halted during granulation of the particulates with the other granulators, and then one of the other granulators halts granulation, the granulator on standby begins granulation in place of the granulator that has halted granulation,
while the granulator that has halted granulation has its die exchanged with one provided with through-holes having a hole diameter smaller than the first particle diameter and second particle diameter, after which it is put on standby with its granulation halted until one of the other granulators has its granulation halted.

5. The method of producing animal litter according to claim 1, wherein the first particle diameter is 1.1 to 2.0 times the initial value of the hole diameter of the through-holes of the die.

6. The method of producing animal litter according to claim 1, wherein the second particle diameter is 1.05 to 1.5 times the initial value of the hole diameter of the through-holes of the die.

7. The method of producing animal litter according to claim 1, wherein the thickness of the die of the granulator is 1 to 100 mm.

8. The method of producing animal litter according to claim 1, wherein the material of the die of the granulator is iron, steel or stainless steel.

9. The method of producing animal litter according to claim 1, wherein the molding material has a water content of 15 to 40 mass % when loaded into the granulator.

10. The method of producing animal litter according to claim 2, wherein, when granulation of at least one of the plurality of granulators has been halted, and the amount of granulation of particulates by granulation with all of the plurality of granulators falls below the predetermined target amount of granulation of particulates, due to the effect of the granulator whose granulation has been halted, the amount of granulation of particulates of the other granulators is increased in order to maintain the predetermined target amount of granulation of the particulates.

11. The method of producing animal litter according to claim 2, wherein the first particle diameter is 1.1 to 2.0 times the initial value of the hole diameter of the through-holes of the die.

12. The method of producing animal litter according to claim 3, wherein the first particle diameter is 1.1 to 2.0 times the initial value of the hole diameter of the through-holes of the die.

13. The method of producing animal litter according to claim 10, wherein the first particle diameter is 1.1 to 2.0 times the initial value of the hole diameter of the through-holes of the die.

14. The method of producing animal litter according to claim 4, wherein the first particle diameter is 1.1 to 2.0 times the initial value of the hole diameter of the through-holes of the die.

15. The method of producing animal litter according to claim 2, wherein the second particle diameter is 1.05 to 1.5 times the initial value of the hole diameter of the through-holes of the die.

16. The method of producing animal litter according to claim 3, wherein the second particle diameter is 1.05 to 1.5 times the initial value of the hole diameter of the through-holes of the die.

17. The method of producing animal litter according to claim 10, wherein the second particle diameter is 1.05 to 1.5 times the initial value of the hole diameter of the through-holes of the die.

18. The method of producing animal litter according to claim 4, wherein the second particle diameter is 1.05 to 1.5 times the initial value of the hole diameter of the through-holes of the die.

19. The method of producing animal litter according to claim 14, wherein the second particle diameter is 1.05 to 1.5 times the initial value of the hole diameter of the through-holes of the die.

20. The method of producing animal litter according to claim 5, wherein the second particle diameter is 1.05 to 1.5 times the initial value of the hole diameter of the through-holes of the die.
